(19) United States
(12) Patent Application Publication
(10) Pub. No.: US 2003/0164648 A1
(43) Pub. Date: Sep. 4, 2003

(54) Four-pole torque motor

(76) Inventor: Robert J. Byram, Grand Blanc, MI (US)

Correspondence Address: VINCENT A CICHOSZ, DELPHI TECHNOLOGIES, INC., Legal Staff Mail Code: 480-414-420, P.O. Box 5052, Troy, MI, 48007-5052, US

(21) Appl. No.: 10/087,434

(22) Filed: Mar. 1, 2002

(51) Int. Cl. H02K 33/00; H02K 35/00; H02K 1/12

(52) U.S. Cl. 310/36; 310/254

(57) ABSTRACT

A four pole torque motor including a rotor assembly having a magnetic device, a motor core and a motor shaft, a stator having four stator members, wherein the stator is disposed so as to be surroundingly associated with the rotor assembly, a single motor coil, wherein the motor coil is disposed so as to be surroundingly associated with the stator and a motor housing having a housing body, wherein the housing body defines a housing cavity for containing the rotor assembly, the stator and the motor coil.

### BACKGROUND

A device that controllably produces a rotational movement is referred to as a rotational actuator or a torque motor. Torque motors are well known and are used to actuate various types of valves that require only a limited angle of rotation. Because they do not need a gearing system, torque motors tend to be much more simpler and reliable then conventional motors. One common type of torque motor design employs a two-pole radial magnetic circuit having only one coil. Although cost and size is decreased and simplicity is increased due to the need for only one coil, this design tends to suffer from low torque due to the rotation angle being more than ninety degrees. As such, two-pole motors are better suited for applications requiring rotation angles greater than ninety degrees.

Another common type of torque motor design employs a four-pole axial circuit having four coils. Because this design type can have up to two times the torque of a two-pole motor, applications that require a large amount of torque and rotation angles less than ninety degrees are better served by a four-pole motor design rather than a two-pole motor design. Although this design optimizes torque output for a required angle, the cost, complexity and difficulty of manufacturability is increase over the single coil design. This is because the design and connection methods for a four coil design requires a greater deal of complexity than the one coil design, thus increasing the cost.

### BRIEF SUMMARY

A four pole torque motor comprising: a rotor assembly having a magnetic device, a motor core and a motor shaft; a stator having four stator members, wherein the stator is disposed so as to be surroundingly associated with the rotor assembly; a single motor coil, wherein the motor coil is disposed so as to be surroundingly associated with the stator; and a motor housing having a housing body, wherein the housing body defines a housing cavity for containing the rotor assembly, the stator and the motor coil.

### BRIEF DESCRIPTION OF THE DRAWINGS

The present invention will now be described, by way of an example, with references to the accompanying drawings, wherein like elements are numbered alike in the several figures in which:

FIG. 1 shows an exploded view of a four-pole torque motor in accordance with an exemplary embodiment;

FIG. 2a shows a top down view of a four-pole torque motor in accordance with an exemplary embodiment;

FIG. 2b shows a side cross sectional view of a four-pole torque motor in accordance with an exemplary embodiment;

FIG. 3 shows a side view of a four-pole torque motor in accordance with an exemplary embodiment;

FIG. 4a shows a top down view of a stator pole in accordance with an exemplary embodiment;

FIG. 4b shows a front view of a stator pole in accordance with an exemplary embodiment; and

FIG. 4c shows a trimetric perspective view of a stator pole in accordance with an exemplary embodiment.

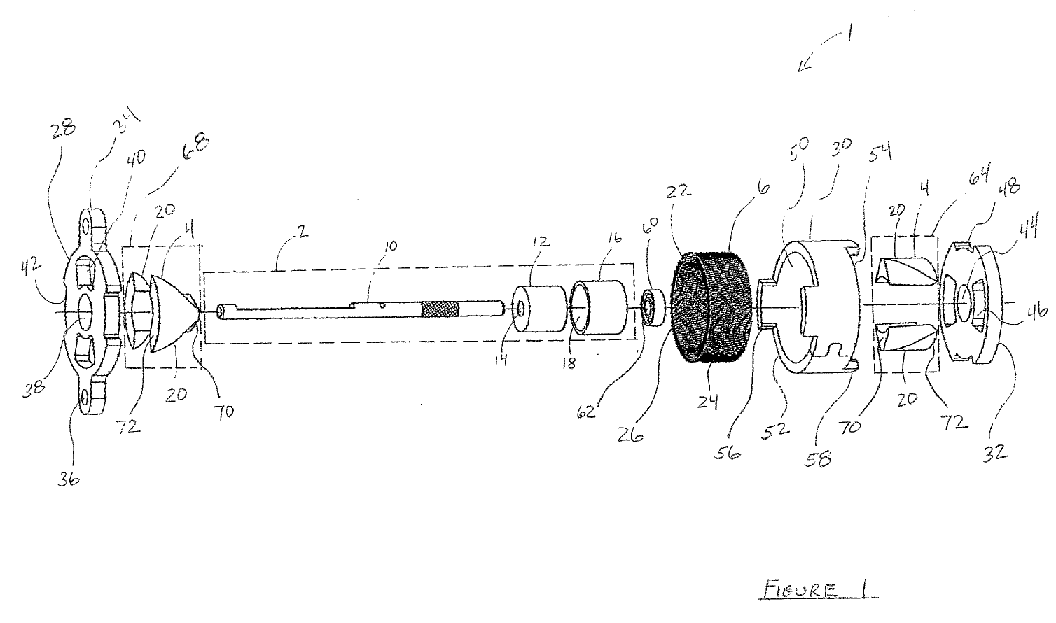

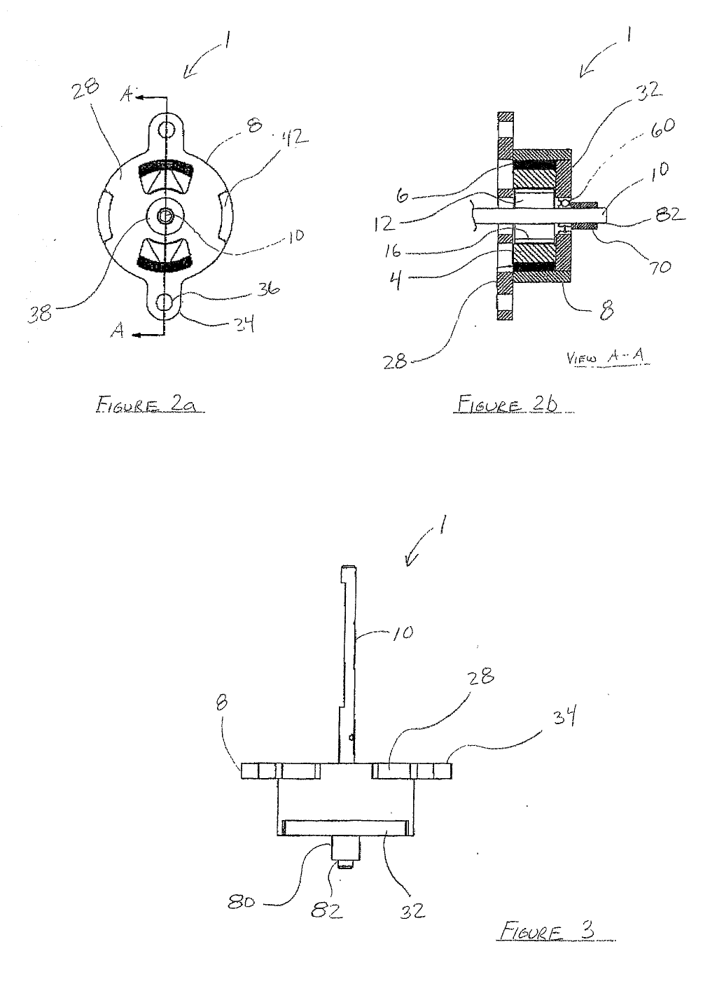

### DETAILED DESCRIPTION OF AN EXEMPLARY EMBODIMENT

Referring to the drawings, a four-pole torque motor 1 is shown having a rotor assembly 2, a stator 4, a motor coil 6 and a motor housing 8 in accordance with an exemplary embodiment. Rotor assembly 2 preferably includes a motor shaft 10, a motor core 12 having a core cavity 14 and a magnetic device 16 having a magnetic cavity 18. In accordance with an exemplary embodiment, motor shaft 10 is preferably disposed so as to be non-movably contained within core cavity 14 and motor core 12 is preferably disposed so as to be non-movably contained within magnetic cavity 18.

Stator 4 preferably includes four stator members 20, wherein each of the stator members 20 are disposed so as to be perpendicularly adjacent with two of the remaining stator members 20, thus disposing stator 4 so as to surround rotor assembly 2 wherein rotor assembly 2 is rotatingly associated with stator 4. Each of stator members 20 preferably includes a stator top 70 and a stator base 72. In addition, stator members 20 preferably include two upright stator members 64 and two inverted stator members 68, wherein each of the upright stator members 64 is disposed so as to be opposite each other and wherein each of the inverted stator members 68 is disposed so as to be opposite each other.

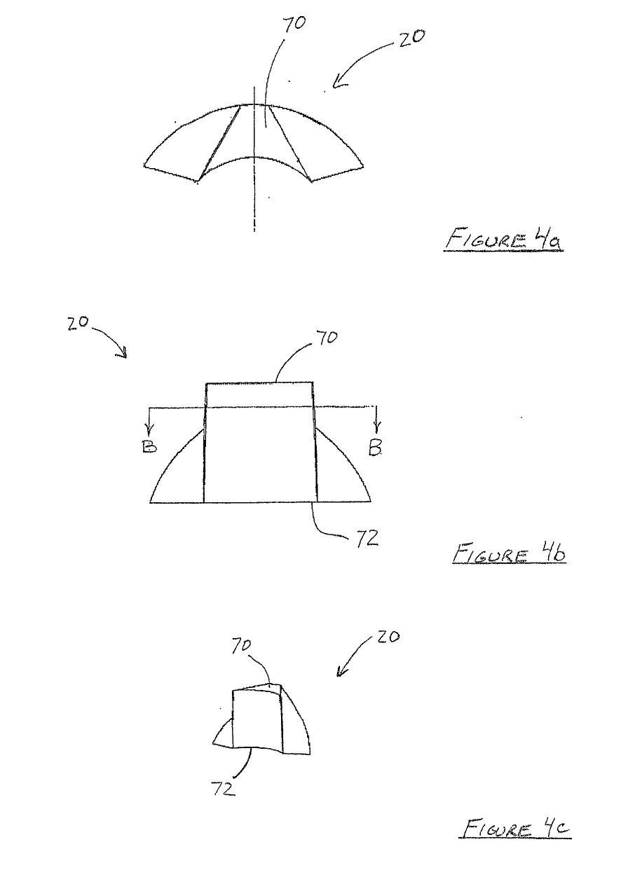

Referring to FIG. 4a, FIG. 4b and FIG. 4c, each of stator members 20 are preferably shaped so as to be symmetrical, wherein stator base 72 has a larger surface area than stator top 70. In accordance with an exemplary embodiment, each of stator members 20 are preferably further shaped such that the cross-sectional area B-B increases in the direction of the flux current path as the flux is increased due to an increasing magnet surface area. Moreover, stator members 20 are preferably disposed such that stator top 70 of upright stator members 64 are adjacent stator base 72 of inverted stator members 68.

Motor coil 6 preferably includes a coil bobbin 22 and a coil wire 24, wherein coil wire 24 is preferably wrapped around coil bobbin 22. In addition, coil bobbin 22 preferably defines a coil cavity 26, wherein stator 4 is disposed so as to be non-movably contained within coil cavity 26.

In accordance with an exemplary embodiment, motor housing 8 preferably includes a top plate 28, a housing body 30 and a base plate 32. Top plate 28 preferably includes two protrusions 34, each of which includes a mounting cavity 36. In addition, top plate 28 also includes a top plate shaft cavity 38, a top plate vent cavity 40 and two top plate receiving notches 42. Base plate 32 is preferably similar in shape to top plate 28 and includes a base plate shaft cavity 44, a base plate vent cavity 46 and two base plate receiving notches 48. Housing body 30 is preferably similar in shape to top plate 28 and defines a housing cavity 50 for containing rotor assembly 2, motor coil 4 and stator 6. In addition, housing body 30 preferably includes a body top 52 and a body base 54, wherein body top 52 includes two protruding top edges 56 and body base 54 includes two protruding base edges 58.

In accordance with an exemplary embodiment, four-pole torque motor 1 includes a device bearing 60 defining a bearing cavity 62. Device bearing 60 is preferably disposed within base plate shaft cavity 44 so as to be non-movably associated with base plate 32. In addition, device bearing 60 is preferably disposed within base plate shaft cavity 44 so as to allow communication with housing cavity 50 via bearing cavity 62. Moreover, four-pole torque motor 1 preferably includes a collar shaft 80 defining a collar shaft cavity 82. Collar shaft 80 is preferably disposed such that motor shaft 10 is disposed within collar shaft cavity 82 and collar shaft 80 is adjacent to device bearing 60. In addition, collar shaft 80 is preferably non-movably associated with motor shaft 10.

In accordance with an exemplary embodiment, top plate 28 is preferably disposed relative to body top 52 such that protruding top edges 56 are contained within top plate receiving notches 42. In addition, top plate 28 is preferably non-movably associated with housing body 30. Also, in accordance with an exemplary embodiment, base plate 32 is preferably disposed relative to body base 54 such that protruding base edges 58 are contained within base plate receiving notches 48. In addition, base plate 32 is preferably non-movably associated with housing body 30. Moreover, top plate 28 and base plate 32 are preferably disposed so as to enclose housing cavity 50. Rotor assembly 2, stator 4 and motor coil 6 are preferably disposed within housing cavity 50 such that motor shaft 10 is protruding from top plate shaft cavity 38 and base plate shaft cavity 44 via bearing cavity 62, such that motor shaft 10 is rotatingly associated with housing body 30.

In accordance with an exemplary embodiment, top plate 28 is preferably disposed, relative to inverted stator members 68, so as to be electrically communicated with each stator base 72 of inverted stator members 68. In addition, base plate 32 is preferably disposed, relative to upright stator members 64, so as to be magnetically communicated with each stator base 72 of upright stator members 64.

In accordance with an exemplary embodiment, four-pole torque motor 1 operates as follows. A current is applied to coil wire 24 so as to cause a coil current to flow through coil 6. The coil current flowing through coil 6 creates a magnetic field surrounding coil wire 24 and hence, around coil 6. Because stator 4 is disposed adjacent to coil 6, stator 4 is therefore subjected to this magnetic field and a flux current is induced in each of the four stator members 20, wherein the flux current flows from stator top 70 to stator base 72. In accordance with an exemplary embodiment, this preferably causes the polarity of upright stator members 64 to be 90° out of phase relative to the polarity of inverted stator members 68, and creates a magnetic field that interacts with magnetic device 16 and motor core 12. This interaction creates a torque on rotor assembly 2 causing rotor assembly 2 to rotate.

In accordance with an exemplary embodiment, although the coil current being applied to coil wire 24 is preferably less than 4 amperes, the coil current may be any amount of current suitable to the desired end purpose.

In accordance with an exemplary embodiment, motor core 12 is preferably constructed of iron. However, motor core 12 may be constructed of any material suitable to the desired end purpose. In addition, motor core 12 is preferably non-movably associated with motor shaft 10 via a press fit. However, motor core 12 may be non-movably associated with motor shaft 10 using any device or method suitable to the desired end purpose.

In accordance with an exemplary embodiment, magnetic device 16 is preferably constructed of a rare earth material, such as sintered NeFeB. However, magnetic device 16 may be constructed of any material suitable to the desired end purpose. In addition, magnetic device 16 is preferably non-movably associated with motor core 12 via an adhesive. However, magnetic device 16 may be non-movably associated with motor core 12 using any device or method suitable to the desired end purpose. Moreover, magnetic device 16 is preferably a permanent magnet charged radially and having four alternating poles.

In accordance with an exemplary embodiment, device bearing 60 is preferably non-movably associated with base plate 32 via press fit. However, device bearing 60 may be non-movably associated with base plate 32 using any method or device suitable to the desired end purpose. Moreover, device bearing 60 is preferably non-movably associated with motor shaft 10 via press fit. However, device bearing 60 may be non-movably associated with motor shaft 10 using any method or device suitable to the desired end purpose.

In accordance with an exemplary embodiment, top plate 28 and base plate 32 may be non-movably associated with housing body 30 using any method or device suitable to the desired end purpose.

In accordance with an exemplary embodiment, top plate 28 and base plate 32 preferably include key slots disposed on the internal surface of top plate 28 and base plate 32. In addition, coil bobbin 22 preferably includes bobbin slots keyed to key slots so as to be non-movably associated with top plate 28 and base plate 32.

In accordance with an exemplary embodiment, motor housing 8, stator 4 and motor core 12 are preferably constructed of a magnetic material. However, motor housing 8, stator 4 and motor core 12 may be constructed of any material suitable to the desired end purpose.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A four pole torque motor comprising:
a rotor assembly having a magnetic device, a motor core and a motor shaft;
a stator having four stator members, wherein said stator is disposed so as to be surroundingly associated with said rotor assembly;
a single motor coil, wherein said motor coil is disposed so as to be surroundingly associated with said stator; and
a motor housing having a housing body, wherein said housing body defines a housing cavity for containing said rotor assembly, said stator and said motor coil.

2. A four pole torque motor according to claim 1, wherein said motor shaft is disposed so as to be non-movably associated with said motor core.

3. A four pole torque motor according to claim 1, wherein said magnetic device is disposed so as to be non-movably associated with said motor core.

4. A four pole torque motor according to claim 1, wherein said magnetic device is a permanent magnet charged radially and having four alternating poles.

5. A four pole torque motor according to claim 1, wherein each of said four stator members are disposed so as to be perpendicularly adjacent with two of said four stator members.

6. A four pole torque motor according to claim 1, wherein each of said stator members include a stator cross-sectional area, stator top and a stator base and wherein said stator members are shaped such that said stator cross-sectional area is larger at said stator base than said stator top.

7. A four pole torque motor according to claim 6, wherein said stator cross-sectional area gradually increases from said stator top to said stator base.

8. A four pole torque motor according to claim 6, wherein said stator cross-sectional area gradually increases from said stator top to said stator base in the direction of a flux current path.

9. A four pole torque motor according to claim 1, wherein said motor coil includes a coil bobbin and a coil wire, wherein said coil wire is disposed so as to be wrapped around said coil bobbin.

10. A four pole torque motor according to claim 1, wherein said motor housing includes a top plate and a base plate, wherein said top plate and said base plate are disposed so at to be non-movably associated with said housing body so as to enclose said housing cavity.

11. A four pole torque motor according to claim 10, wherein said top plate includes a top plate receiving notch and wherein said base plate includes a base plate receiving notch.

12. A four pole torque motor according to claim 10, wherein said top plate defines a top plate shaft cavity and wherein said base plate defines a base plate shaft cavity, wherein said top plate shaft cavity and said base plate shaft cavity are disposed so as to allow communication with said motor shaft.

13. A four pole torque motor according to claim 12, further comprising a device bearing, wherein said device bearing is disposed within said base plate shaft cavity so as to be non-movably associated with said base plate and wherein said device bearing is disposed within said base plate shaft cavity so as to be rotatingly associated with said motor shaft.

14. A four pole torque motor according to claim 11, wherein said housing body includes a body top and a body base, wherein said body top includes a protruding top edge and wherein said body base includes a protruding base edge.

15. A four pole torque motor according to claim 14, wherein when said top plate is non-movably associated with said housing body, said protruding top edge is disposed within said top plate receiving notch.

16. A four pole torque motor according to claim 14, wherein when said base plate is non-movably associated with said housing body, said protruding base edge is disposed within said base plate receiving notch.

17. A four pole torque motor comprising:
a rotor assembly having a magnetic device, a motor core and a motor shaft;
a stator having a stator member, wherein said stator is disposed so as to be surroundingly associated with said rotor assembly;
a motor coil, wherein said motor coil is disposed so as to be surroundingly associated with said stator; and
a motor housing having a housing body, wherein said housing body defines a housing cavity for containing said rotor assembly, said stator and said motor coil.

18. A four pole torque motor according to claim 17, wherein said stator includes four of said stator members, wherein each of said stator members are disposed so as to be perpendicularly adjacent with two of said stator members.

19. A four pole torque motor according to claim 17, wherein said each of stator members includes a stator cross-sectional area, a stator top and a stator base and wherein each of said stator members is shaped such that said stator cross-sectional area is larger at said stator base than said stator top.

20. A four pole torque motor according to claim 19, wherein said stator cross-sectional area gradually increases from said stator top to said stator base in the direction of a flux current path.
